(19) United States
(12) Patent Application Publication
(10) Pub. No.: US 2014/0204020 A1
(43) Pub. Date: Jul. 24, 2014

(54) INTERACTIVE CONTENT CONTROL DEVICE BASED ON L-SHAPED DISPLAY AND CONTROL METHOD THEREOF

(71) Applicant: Electronics & Telecommunications Research Institute, Daejeon (KR)

(72) Inventors: Jae Ho LEE, Daejeon (KR); Hee Kwon KIM, Daejeon (KR); Myung Ha KIM, Daejeon (KR); Ji Young PARK, Daejeon (KR); Seung Woo NAM, Daejeon (KR)

(73) Assignee: Electronics & Telecommunications Research Institute, Daejeon (KR)

(21) Appl. No.: 14/146,861

(22) Filed: Jan. 3, 2014

(30) Foreign Application Priority Data
Jan. 18, 2013 (KR) 10-2013-0005692

(51) Int. Cl. G06F 3/01

(52) U.S. Cl. CPC G06F 3/017
USPC 345/156

(57) ABSTRACT

Provided are an interactive content control device and an interactive content control method capable of increasing immersion in content, which include a front display unit that displays content images, a lower side display unit which is configured to form an L shape with the front display unit, displays content images, and interworks with the front display unit, a sensor unit that senses user movements and provides detected sensing information, and a controller that controls interworking of content displayed on the front display unit and the lower side display unit based on the sensing information. Accordingly, a sense of physical distance from the user may be reduced and the user experiences more immersive content and a variety of interfaces may be utilized in content.

### CLAIM FOR PRIORITY

This application claims priority to Korean Patent Application No. 10-2013-0005692 filed on Jan. 18, 2013 in the Korean Intellectual Property Office (KIPO), the entire contents of which are hereby incorporated by reference.

### BACKGROUND

1. Technical Field

Example embodiments of the present invention relate to interactive content, and more particularly, to an interactive content control device based on an L-shaped display and a control method thereof which are capable of increasing immersion in the interactive content and providing a variety of interfaces.

2. Related Art

Methods of controlling content using depth information in midair are gradually being used more in real life. Further, technologies for content control using a touch-sensitive interface on a screen are already being used in everyday life.

In existing interactive content, an interaction is performed with a single display or one side of a plurality of displays on a plane.

A table-shaped display close to hand position of a user may be used to interact with content at close distance, but obtaining spatial information is difficult.

Further, since a certain distance or more needs to be maintained in order to obtain the spatial information with a display disposed at the front, only one-dimensional user interaction is possible and users feel a less immersive feeling.

### SUMMARY

Accordingly, example embodiments of the present invention are provided to substantially obviate one or more problems due to limitations and disadvantages of the related art.

Example embodiments of the present invention provide an interactive content control device based on an L-shaped display which is capable of increasing immersion in content.

Example embodiments of the present invention also provide an interactive content control method based on the L-shaped display which is capable of increasing immersion in content.

In some example embodiments, an interactive content control device based on an L-shaped display includes a front display unit that displays content images, a lower side display unit which is configured to form an L-shape with the front display unit, displays content images, and interworks with the front display unit, a sensor unit that senses user movements and provides detected sensing information, and a controller that controls interworking of content displayed on the front display unit and the lower side display unit based on the sensing information.

Here, the sensing information may include at least one of motion information, spatial information, and interaction information of a user.

The controller performs control such that interactions in midair of the lower side display unit are incorporated into content displayed on the lower side display unit based on the sensing information.

The controller performs control such that interactions in midair of the lower side display unit are incorporated into content displayed on the front display unit based on the sensing information.

The controller performs control such that interactions with content used in the front display unit are reflected in and displayed on the front display unit based on the sensing information.

The controller performs control such that interactions with content used in the front display unit are reflected in and displayed on the lower side display unit based on the sensing information.

The controller performs control such that content used in the lower side display unit is displayed on the front display unit based on the sensing information.

The controller performs control such that content used in the front display unit is displayed on the lower side display unit based on the sensing information.

The controller performs control such that interactions included in the sensing information are reflected in content used in the front display unit and the lower side display unit.

The controller performs control such that content used in the front display unit and the lower side display unit is simultaneously displayed or removed based on the sensing information.

In other example embodiments, an interactive content control method based on the L-shaped display performed in the information processing device includes determining whether sensing information is obtained and displaying content through the front display unit and the display configured to have a form of a table, based on the obtained sensing information, when the sensing information is obtained.

Here, the sensing information may include at least one of motion information, spatial information, and interaction information of the user.

### BRIEF DESCRIPTION OF DRAWINGS

Example embodiments of the present invention will become more apparent by describing in detail example embodiments of the present invention with reference to the accompanying drawings, in which:

FIG. 1 is a front view of an interactive content control device based on an L-shaped display according to an example embodiment of the invention.

FIG. 2 is a conceptual diagram illustrating a spatial layout of the interactive content control device based on the L-shaped display according to the example embodiment of the invention.

FIG. 3 is a perspective view illustrating the interactive content control device based on the L-shaped display according to the example embodiment of the invention.

FIG. 4 is a plan view illustrating the interactive content control device based on the L-shaped display according to the example embodiment of the invention.

FIG. 5 is a block diagram illustrating a configuration of the interactive content control device based on the L-shaped display according to the example embodiment of the invention.

FIG. 6 is a flowchart illustrating an interactive content control method performed in the interactive content control device based on the L-shaped display according to the example embodiment of the invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, the invention will be described in detail by explaining exemplary embodiments of the invention with reference to the accompanying drawings. In order to facilitate overall understanding of the invention, like reference numerals in the drawings denote like elements, and thus the description thereof will not be repeated.

In an interactive content control device based on an L-shaped display according to an example embodiment of the invention, a front display unit 110 disposed in front of a user and a lower side display unit 120 having a form of a table are interworked each other, and motion information, spatial information, and interaction information of the user are used. Hereinafter, a layout of the display units and a usage method thereof will be described with reference to accompanying drawings.

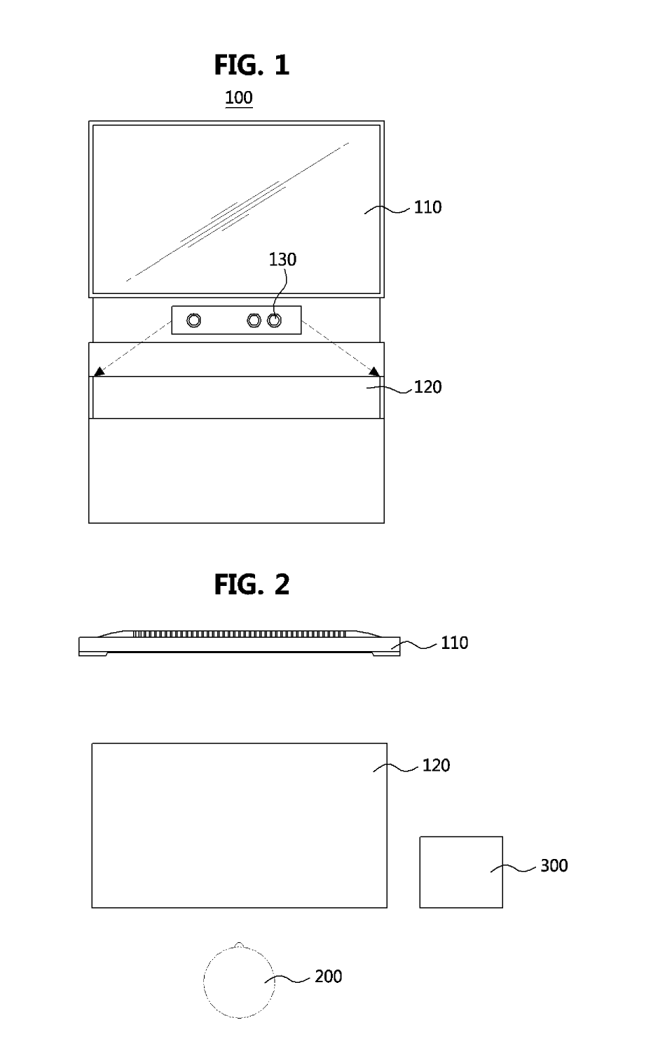

FIG. 1 is a front view of the interactive content control device based on the L-shaped display according to the example embodiment of the invention.

As illustrated in FIG. 1, the interactive content control device based on the L-shaped display 100 according to the example embodiment of the invention may include the front display unit 110 which is disposed in front of the user when the user uses the interactive content control device based on the L-shaped display 100, the lower side display unit 120 which is configured to have a form of a table with a predetermined length so as to maintain a certain distance between the user and the front display unit 110, a sensor unit 130 that obtains and provides user information in midair and a controller (refer to 140 in FIG. 5) that controls the front display unit 110 and the lower side display unit 120.

The front display unit 110 is a display unit disposed in front of the user who uses the interactive content control device based on the L-shaped display 100 and displays content images based on a control signal provided from the controller (refer to 140 in FIG. 5).

The lower side display unit 120 has a form of a table and is disposed to have an L-shape with the front display unit 110. When the user who uses the interactive content control device based on the L-shaped display 100 is positioned in front thereof in order to use the interactive content control device based on the L-shaped display 100, the lower side display unit 120 may be configured to have a predetermined length so as to separate the user from the front display unit 110 by a certain distance or more.

Here, since the lower side display unit 120 is configured to have a predetermined length, the midair sensing information on the user may be easily obtained from the sensor unit 130.

The sensor unit 130 may be, for example, a spatial depth information sensor, and obtains sensing information including motion information, spatial information, interaction information, and movement information of the user, and provides the obtained sensing information to the controller (refer to 140 in FIG. 5).

As illustrated in FIG. 1, the sensor unit 130 may be disposed under the front display unit 110 or above the front display unit 110, or may be disposed differently based on the characteristics of content and interactions.

Accordingly, in the interactive content control device 100 based on the L-shaped display according to the example embodiment of the invention, a sense of physical distance from the user may be reduced and the user may experience more immersive interactive content based on the sensing information provided from the sensor unit 130. Furthermore, a variety of interfaces may be utilized in content.

FIG. 2 is a conceptual diagram illustrating a spatial layout of the interactive content control device based on the L-shaped display according to the example embodiment of the invention.

As illustrated in FIG. 2, in the interactive content control device 100 based on the L-shaped display, the front display unit 110 may be disposed in front of the user 200, and the lower side display unit 120, which is configured to have a form of a table and to have an L shape with the front display unit 110 and displays images, may be disposed.

Here, the lower side display unit 120 may have a predetermined length so as to maintain a certain distance (for example, 240 cm) between the front display unit 110 and the user 200.

The lower side display unit 120 may increase immersion in content by allowing the user to interact with content in close proximity.

Furthermore, an output device 300, for example, a printer and a copy machine, may be disposed to physically feed back the interaction result.

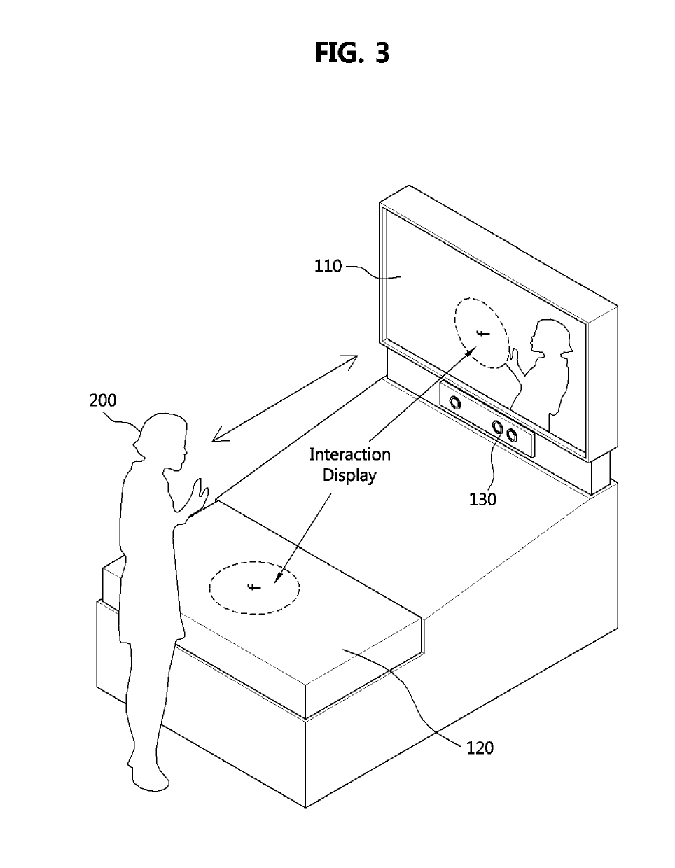

FIG. 3 is a perspective view illustrating the interactive content control device based on the L-shaped display according to the example embodiment of the invention and is an exemplary diagram utilizing interactions.

As illustrated in FIG. 3, interactions between the user 200 and the content may be simultaneously checked in the front display unit 110 and lower side display unit 120.

An actual appearance of the user 200 is projected to the front display unit 110 and mixed with the graphic object so as to implement augmented reality, and the implemented augmented reality may be checked.

Accordingly, the user experiences more immersive content and a variety of interfaces may be reflected in the content.

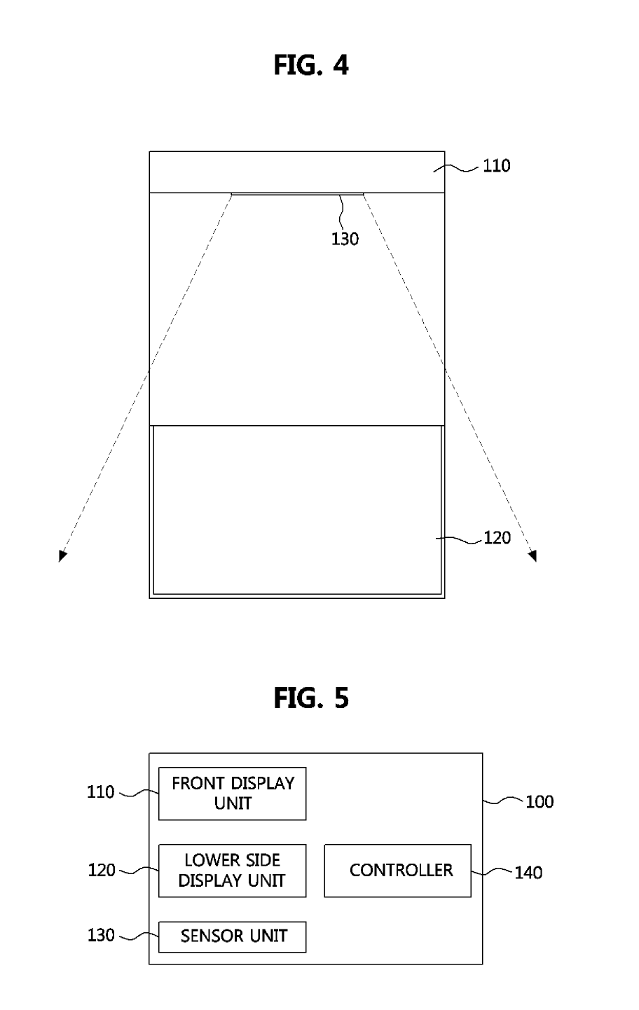

FIG. 4 is a plan view illustrating the interactive content control device based on the L-shaped display according to the example embodiment of the invention.

As illustrated in FIG. 4, in the interactive content control device based on the L-shaped display 100 according to the example embodiment of the invention, graphic content is displayed on the lower side display unit 120. When the displayed content is manipulated in midair or the sensing information on the interaction is obtained, the content in which the sensing information is reflected may be displayed on the front display unit 110 and the lower side display unit 120 based on the sensing information.

A configuration having only the front display unit has a problem in that a certain distance needs to be maintained in order to obtain the spatial information so that only one-dimensional user interaction is possible and users feel a less immersive feeling. On the other hand, a configuration having only the lower side unit has a problem in that obtaining spatial information is difficult. However, in the interactive content control device 100 based on the L-shaped display according to the example embodiment of the invention, such problems may be addressed.

FIG. 5 is a block diagram illustrating a configuration of the interactive content control device based on the L-shaped display according to the example embodiment of the invention.

As illustrated in FIG. 5, the interactive content control device 100 based on the L-shaped display according to the example embodiment of the invention may include the front display unit 110, the lower side display unit 120, the sensor unit 130 and the controller 140.

First, the front display unit 110 displays images under the control of the controller 140.

Here, the front display unit 110 may provide an image display screen in front of the user who uses the interactive content control device based on the L-shaped display 100.

The lower side display unit 120 displays images under the control of the controller 140, may be configured to have a form of a table with a predetermined length so as to separate the user from the front display unit 110 by a certain distance or more, and may be disposed to have an L-shape with the front display unit 110.

Moreover, the lower side display unit 120 interworks with the front display unit 110, thereby displaying the interaction content.

Examples of the front display unit 110 and the lower side display unit 120 may include a liquid crystal display (LCD), a plasma display panel (PDP), and an organic light emitting diode (OLED).

The sensor unit 130 obtains the sensing information sensed in midair and provides the obtained sensing information to the controller 140.

Here, the sensor unit 130 may be, for example, a spatial depth information sensor. The sensing information may include midair motion information, spatial information, and interaction information of the user.

The sensor unit 130 may be disposed under or above the front display unit 110 or may be disposed differently based on the characteristics of content and interactions.

The controller 140 controls the front display unit 110 and the lower side display unit 120 based on the sensing information provided from the sensor unit 130.

Hereinafter, spatial interface utilizations performed in the controller 140 will be exemplified.

The controller 140 performs control such that interactions in midair of the lower side display unit 120 are incorporated into the content displayed on the lower side display unit 120 based on the sensing information, thereby displaying them on the lower side display unit 120.

In addition, the controller 140 performs control such that interactions in midair of the lower side display unit 120 are incorporated into the content displayed on the front display unit 110 based on the sensing information, thereby displaying them on the front display unit 110.

Further, the controller 140 performs control such that interactions with content displayed on the front display unit 110 are incorporated into the front display unit 110 based on the sensing information, thereby displaying them on the front display unit 110.

Furthermore, the controller 140 performs control such that interactions with content displayed on the front display unit 110 are incorporated into the lower side display unit 120 based on the sensing information, thereby displaying them on the lower side display unit 120.

Moreover, the controller 140 performs control such that content displayed on the lower side display unit 120 is displayed on the front display unit 110 based on the sensing information.

In addition, the controller 140 performs control such that content displayed on the front display unit 110 is displayed on the lower side display unit 120 based on the sensing information.

Moreover, the controller 140 performs control such that interactions included in the sensing information are incorporated into content displayed on the front display unit 110 and the lower side display unit 120 based on the sensing information, thereby displaying them on the front display unit 110 and the lower side display unit 120.

In addition, the controller 140 performs control such that content displayed on the front display unit 110 and the lower side display unit 120 is or is not simultaneously displayed based on the sensing information.

A configuration having only the front display unit has a problem in that a certain distance needs to be maintained in order to obtain the spatial information so that only one-dimensional user interaction is possible and users feel a less immersive feeling. On the other hand, a configuration having only the lower side unit has a problem in that obtaining spatial information is difficult. However, in the interactive content control device 100 based on the L-shaped display according to the example embodiment of the invention, such problems may be addressed.

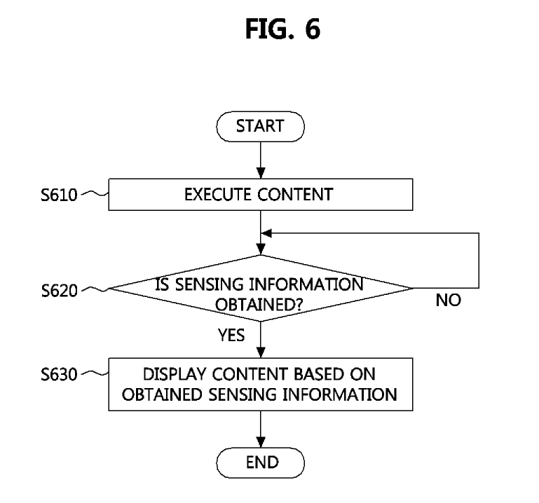

FIG. 6 is a flowchart illustrating an interactive content control method performed in the interactive content control device based on the L-shaped display according to the example embodiment of the invention.

As illustrated in FIG. 6, the interactive content control device based on the L-shaped display 100 causes content to be executed based on an input signal (S610).

Then, the interactive content control device based on the L-shaped display 100 determines whether the sensing information is obtained (S620).

Here, the interactive content control device based on the L-shaped display 100 may obtain the sensing information using, for example, a spatial depth information sensor. The sensing information may include midair motion information, spatial information, and interaction information of the user.

When the sensing information is obtained in step S620, the interactive content control device based on the L-shaped display 100 displays the interaction content created based on the obtained sensing information on the display units disposed in an L-shape (S630).

More specifically, the interactive content control device based on the L-shaped display 100 allows interactions in midair of the lower side display unit 120 in FIG. 5 to be incorporated into content displayed on the lower side display unit 120 in FIG. 5 based on the sensing information.

In addition, the interactive content control device based on the L-shaped display 100 allows interactions in midair of the lower side display unit 120 in FIG. 5 to be incorporated into content displayed on the front display unit 110 in FIG. 5 based on the sensing information.

Further, the interactive content control device based on the L-shaped display 100 allows interactions with content used in the front display unit 110 in FIG. 5 to be reflected in and displayed on the front display unit 110 in FIG. 5 based on the sensing information.

Furthermore, the interactive content control device based on the L-shaped display 100 allows interactions with content used in the front display unit 110 in FIG. 5 to be reflected in and displayed on the lower side display unit 120 in FIG. 5 based on the sensing information.

Moreover, the interactive content control device based on the L-shaped display 100 allows content used in the lower side display unit 120 in FIG. 5 to be displayed on the front display unit 110 in FIG. 5 based on the sensing information.

In addition, the interactive content control device based on the L-shaped display 100 allows content used in the front display unit 110 in FIG. 5 to be displayed on the lower side display unit 120 in FIG. 5 based on the sensing information.

Further, the interactive content control device based on the L-shaped display 100 allows interactions included in the sensing information to be reflected in content used in the front display unit 110 in FIG. 5 and the lower side display unit 120 in FIG. 5 based on the sensing information.

Furthermore, the interactive content control device based on the L-shaped display 100 can control such that content used in the front display unit 110 in FIG. 5 and the lower side display unit 120 in FIG. 5 is or is not simultaneously displayed based on the sensing information.

Examples of the front display unit 110 and the lower side display unit 120 may include a liquid crystal display (LCD), a plasma display panel (PDP), and an organic light emitting diode (OLED).

A configuration having only the front display unit has a problem in that a certain distance needs to be maintained in order to obtain the spatial information so that only one-dimensional user interaction is possible and users feel a less immersive feeling. On the other hand, a configuration having only the lower side unit has a problem in that obtaining spatial information is difficult. However, in the interactive content control method based on the L-shaped display performed in the interactive content control device 100 based on the L-shaped display according to the example embodiment of the invention, such problems may be addressed.

According to the interactive content control device based on the L-shaped display of the example embodiment of the invention and the control method thereof, the content display is controlled such that the front display unit displays images in front of a user based on the sensing information provided from the sensor unit and the lower side display unit, which is configured to have a form of a table with a predetermined length, displays images and interworks with the front display unit.

A configuration having only the front display unit has a problem in that a certain distance needs to be maintained in order to obtain the spatial information in the front display unit so that only one-dimensional user interaction is possible and users feel a less immersive feeling. On the other hand, a configuration having only the lower side unit has a problem in that obtaining spatial information is difficult. However, according to the example embodiment of the invention, such problems may be addressed.

While the example embodiments of the present invention and their advantages have been described in detail, it should be understood by those skilled in the art that various changes, substitutions and alterations may be made herein without departing from the scope of the invention as defined by the appended claims.

What is claimed is:

1. An interactive content control device comprising:
a front display unit that displays content images;
a lower side display unit which is configured to form an L-shape with the front display unit, displays content images, and interworks with the front display unit;
a sensor unit that senses user movements and provides detected sensing information; and
a controller that controls interworking of content displayed on the front display unit and the lower side display unit based on the sensing information.

2. The interactive content control device of claim 1, wherein the sensing information includes at least one of motion information, spatial information, and interaction information of a user.

3. The interactive content control device of claim 1, wherein the controller performs control such that interactions in midair of the lower side display unit are incorporated into content displayed on the lower side display unit based on the sensing information, and are thereby displayed on the lower side display unit.

4. The interactive content control device of claim 1, wherein the controller performs control such that interactions in midair of the lower side display unit are incorporated into content displayed on the front display unit based on the sensing information, and are thereby displayed on the front display unit.

5. The interactive content control device of claim 1, wherein the controller performs control such that interactions with content displayed on the front display unit are incorporated into the front display unit based on the sensing information, and are thereby displayed on the front display unit.

6. The interactive content control device of claim 1, wherein the controller performs control such that interactions with content displayed on the front display unit are incorporated into the lower side display unit based on the sensing information, and are thereby displayed on the lower side display unit.

7. The interactive content control device of claim 1, wherein the controller performs control such that content displayed on the lower side display unit is displayed on the front display unit based on the sensing information.

8. The interactive content control device of claim 1, wherein the controller performs control such that content displayed on the front display unit is displayed on the lower side display unit based on the sensing information.

9. The interactive content control device of claim 1, wherein the controller performs control such that interactions included in the sensing information are incorporated into content displayed on the front display unit and the lower side display unit based on the sensing information, and are thereby displayed on the front display unit and the lower side display unit.

10. The interactive content control device of claim 1, wherein the controller performs control such that content displayed on the front display unit and the lower side display unit is simultaneously displayed or removed based on the sensing information.

11. An interactive content control method based on an L-shaped display that is performed in an information processing device, the method comprising:
determining whether sensing information is obtained; and
displaying content interworked through a front display unit and a lower side display unit, which is configured to form an L shape with the front display unit, based on the obtained sensing information when the sensing information is obtained.

12. The interactive content control method of claim 11, wherein the sensing information includes at least one of motion information, spatial information, and interaction information of a user.
